(19) United States
(12) Patent Application Publication
(10) Pub. No.: US 2012/0049900 A1
(43) Pub. Date: Mar. 1, 2012

(54) DC-DC CONVERTER

(75) Inventors: Alessandro ZAFARANA, Milano (IT); Cristian Porta, Canegrate (IT); Osvaldo Enrico Zambetti, Milano (IT)

(73) Assignee: STMicroelectronics S.r.l., Agrate Brianza (MI) (IT)

(21) Appl. No.: 13/215,605

(22) Filed: Aug. 23, 2011

(30) Foreign Application Priority Data
Aug. 24, 2010 (IT) VA2010A000061

(51) Int. Cl. G05F 1/56

(52) U.S. Cl. 327/109

(57) ABSTRACT

A DC-DC converter based switching voltage regulator circuit is for powering a microprocessor including regulated power supplies configured to produce different output voltages. The DC-DC converter has an output power stage configured to generate a regulated DC supply voltage and comprising a plurality of power transistors. A driver circuit is configured to drive the plurality of power transistors at an adjustable drive voltage in response to a drive control signal. Circuitry is configured to adaptively adjust the adjustable drive voltage and has a voltage selector configured to select between at least two different output voltages for the regulated power supplies of the microprocessor to be coupled to the driver circuit. The voltage selector is controlled by a state logic signal generated based upon logic signals generated by the microprocessor, the state logic signal indicating whether the microprocessor is entering a given power state.

### FIELD OF THE INVENTION

This invention relates to power converters, and, more particularly, to a DC-DC converter for supplying a microprocessor, controlled by the supplied microprocessor itself.

### BACKGROUND OF THE INVENTION

Voltage regulators provide the constant DC output voltage and contain circuitry that keeps the output voltage at a regulated level on a supplied load. This task is typically accomplished by a switching power stage, the switches of which are turned on/off by respective driver circuits.

Usually, the drive voltages to be delivered by the drive circuits for turning on (or off) the power switches of the output power stage may assume one of two possible values V1 and V2. It is considered convenient to have at least two different drive voltages in order to reduce dissipation in the switches when conducting and the power required for switching them on/off.

Power losses for turning on/off the switches are proportional to the square of the drive voltage, but the internal resistance of the switches in a conduction state is inversely proportional to the drive voltage. Therefore, when a relatively large current is absorbed by the load, it may be convenient to have a relatively high drive voltage for reducing conduction losses. On the contrary, when the load absorbs a relatively small current, it is convenient to have a lower drive voltage in order to reduce switching losses.

The published U.S. patent application No. 2010/0007320 relates to a control technique whereby a drive voltage substantially proportional to the current absorbed by the load is generated with a linear regulator, as shown in FIG. 1. Unfortunately, this produces a small improvement because the linear regulator absorbs a certain power, that adds up to the switching and conduction power losses.

To overcome this drawback, in the above-mentioned US patent application the circuit shown in FIG. 2 is disclosed, wherein the drive voltage is generated by a second switching converter, more efficient than the linear regulator of FIG. 1. This increases the fabrication costs because it requires two converters instead of one.

A DC-DC converter specifically adapted for supplying microprocessors, that is simple to realize and that allows to reduce significantly switching and conduction power losses is therefore desirable.

### SUMMARY OF THE INVENTION

A cost-effective DC-DC converter adapted to supply a microprocessor with a regulated voltage and adapted to be controlled by the supplied microprocessor itself has been found that cures the drawbacks of the prior art.

The DC-DC converter of this disclosure has means or circuitry for switching the drive voltage of the switches of the output power stage from a low value V1 to a high value V2 and vice versa, in the form of a dedicated circuit controlled by the same microprocessor that is supplied by the converter.

The switching from the high drive voltage V2 to the low drive voltage V1 and vice versa is controlled by the value that is assumed by a logic signal or signals generated by the microprocessor indicative of the fact that the microprocessor is about to enter a certain power state.

### BRIEF DESCRIPTION OF THE DRAWINGS

FIG. 1 depicts a switching driver stage supplied a voltage generated by a linear regulator as in the prior art.

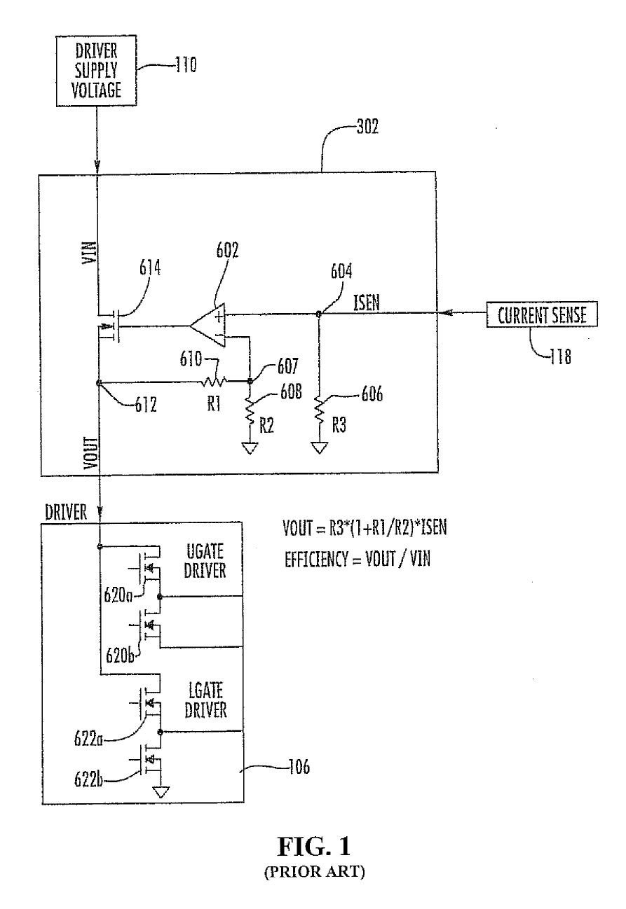

FIG. 2 depicts a switching driver stage supplied a voltage generated by a switching regulator as in the prior art.

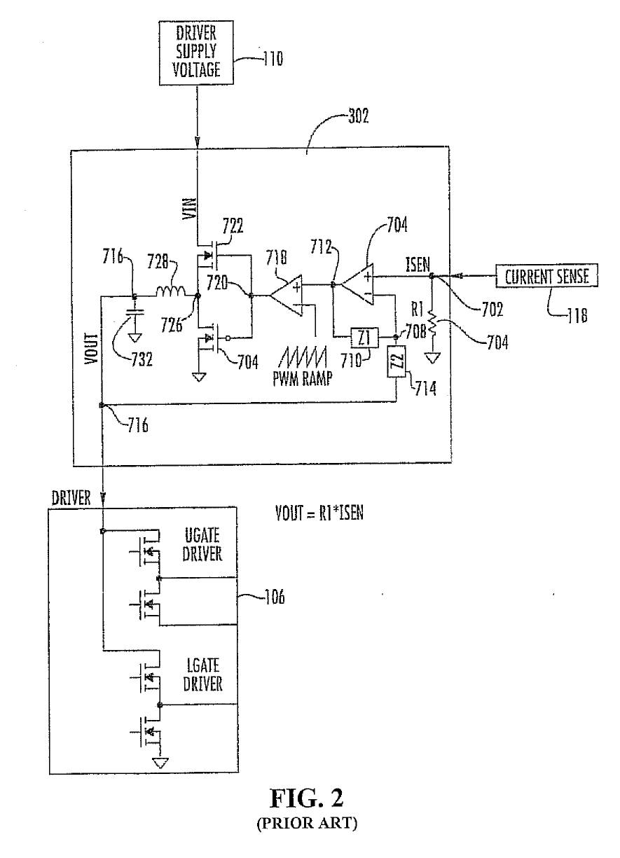

FIG. 3 depicts a DC-DC converter adapted to supply a microprocessor, wherein the drive voltage may be switched between two voltages V1 and V2 by the supplied microprocessor itself.

FIG. 4 depicts an exemplary embodiment of the circuit ANTI-CROSS of FIG. 3 and an exemplary time graph of its main signals.

### DETAILED DESCRIPTION OF THE PREFERRED EMBODIMENTS

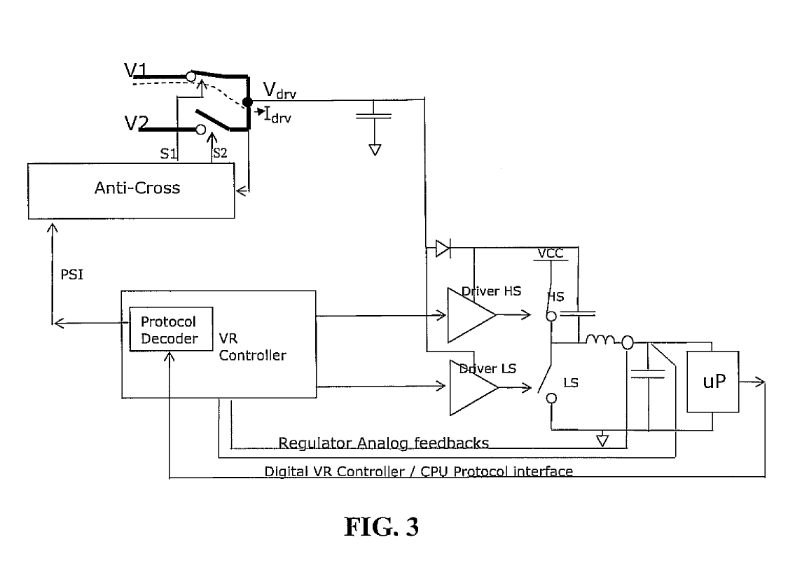

A DC-DC converter particularly adapted to supply a microprocessor is shown in FIG. 3. The power switches HS and LS may be driven either with a high voltage V2, when a relatively great current is to be used by the microprocessor (full power functioning state), or with a low voltage V1, when the microprocessor works in a low-power functioning state. A higher drive voltage is supplied when the functioning state of the microprocessor is at full power for reducing conduction losses of the power switches, and the lower drive voltage V1 is supplied when the microprocessor is functioning at a reduced power state for reducing switching losses of the switches HS and LS.

A characteristic feature of the DC-DC converter is the fact that the circuit ANTI-CROSS that switches the drive voltage Vdrv from the high voltage V2 to the low voltage V1 and vice versa is controlled by the supplied microprocessor itself through a feedback logic signal or signals indicative of the fact that the microprocessor is about to enter a certain functioning state, such as a low-power state.

This feedback signal may be either a flag purposely generated by the microprocessor for indicating that the microprocessor is entering in a certain power state, or a group of logic signals generated by the microprocessor from which a controller VR CONTROLLER of the power switches may generate a logic flag PSI using a dedicated circuitry PROTOCOL DECODER, as shown by way of example in FIG. 3. With this, there is no need of sensing the current absorbed by the microprocessor and thus no dedicated current sensor is required.

The block ANTI-CROSS represents a voltage selector for switching from the voltages V2 to V1 and vice versa in a safe manner, avoiding possible short-circuits between the supply lines at the different voltages V1 and V2.

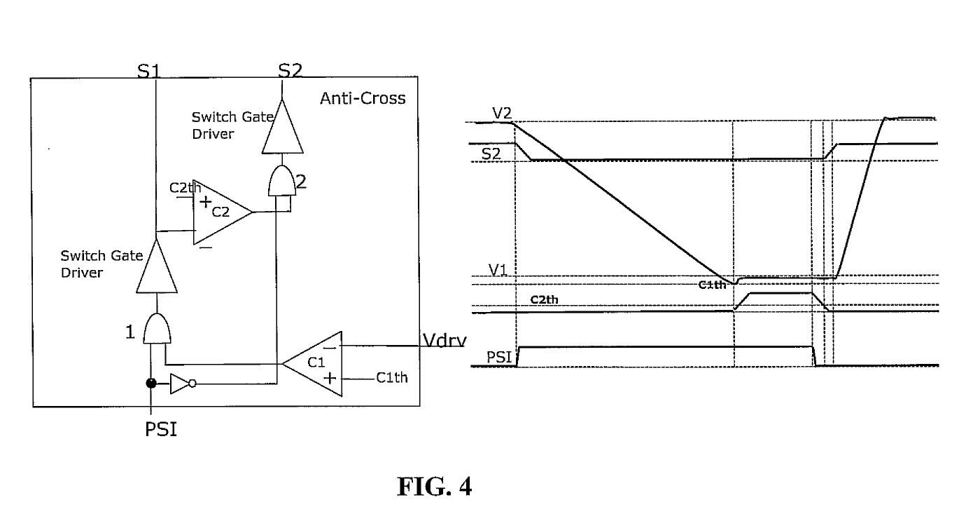

The currently available demultiplexers may not ensure sufficient protection against such short-circuits. For this reason, a purposely designed circuit for a voltage selector, as depicted in FIG. 4, is proposed.

When the flag PSI, irrespectively generated directly by the microprocessor or by a dedicated circuit PROTOCOL DECODER of the controller VR CONTROLLER of the power switches in function of logic signals generated by the microprocessor, switches high, it means that the microprocessor is entering in a certain power state and the switch that connects the line at the voltage V2 is opened (S2 switches low) through the depicted AND gate 1. The drive voltage Vdrv decreases and, when it drops below the threshold C1th, the first comparator C1 generates an active signal. The other AND gate 1 thus switches high the signal S1, and the respective switch on the line at the voltage V1 is closed. In this configuration, the drive voltage Vdrv is the voltage V1.

Similarly, when the logic flag PSI switches low, meaning that the microprocessor is functioning at full power, the signal S1 decreases and the drive voltage Vdrv increases up to attain the high voltage V2.

The DC-DC converter has a very simple architecture and may not use an additional linear regulator or a second switching regulator, as in the known converters. It may be simply controlled by the supplied microprocessor itself, without dedicated current and voltage feedback circuits.

Moreover, the voltage selector illustrated in FIG. 4 allows a safe switching of the drive voltage Vdrv from the high voltage V2 to the low voltage V1 and vice versa.

The claims as filed are integral part of this disclosure and are herein incorporated by reference.

1-4. (canceled)

5. A DC-DC converter based switching voltage regulator circuit for powering a microprocessor including regulated power supplies configured to produce different output voltages, the DC-DC converter comprising:
an output power stage configured to generate a regulated DC supply voltage and comprising a plurality of power transistors;
a driver circuit configured to drive the plurality of power transistors at an adjustable drive voltage in response to a drive control signal;
circuitry configured to adaptively adjust the adjustable drive voltage and comprising
a voltage selector configured to select between at least two different output voltages for the regulated power supplies of the microprocessor to be coupled to said driver circuit,
said voltage selector controlled by a state logic signal generated based upon logic signals generated by the microprocessor, the state logic signal indicating whether the microprocessor is entering a given power state.

6. The DC-DC converter of claim 5, wherein said voltage selector comprises:
selection/de-selection switches configured to selectively couple the different output voltages for the regulated power supplies of the microprocessor to said driver circuit; and
an anti cross-conduction circuit configured to receive the state logic signal, said anti cross-conduction circuit comprising a comparator configured to compare a voltage present at the driver circuit with a first reference voltage corresponding to a deselected drive voltage for inhibiting said anti cross-conduction circuit from closing a corresponding switch for a selected drive voltage for as long as the voltage present at the driver circuit has not yet dropped below the first reference voltage, and configured to switch a reference voltage input to a reference voltage corresponding to the selected drive voltage.

7. The DC-DC converter of claim 6, wherein said selection/de-selection switches comprise P-channel MOS switches having counter-opposed body-drain diodes.

8. The DC-DC converter of claim 6, wherein said anti cross-conduction circuit further comprises:
a first AND gate configured to AND the state logic signal and an output of said comparator, to thereby generate a first drive control signal;
a second comparator configured to compare the first drive control signal with a safety voltage, to thereby generate an active flag when the first drive control signal decreases below the safety voltage; and
a second AND gate configured to AND an inverted replica of the first drive control signal with the active flag, to thereby generate a second drive control signal.

9. A DC-DC converter for powering a microprocessor, the DC-DC converter comprising:
an output power stage configured to generate a regulated DC supply voltage;
a driver circuit configured to drive the output power stage at an adjustable drive voltage in response to drive control signals; and
a voltage selector configured to select between the different output voltages to be coupled to said driver circuit;
said voltage selector controlled by a state logic signal indicating whether the microprocessor is entering a given power state.

10. The DC-DC converter of claim 9, wherein said voltage selector comprises:
selection/de-selection switches configured to selectively couple the different output voltages for the regulated power supplies of the microprocessor to said driver circuit; and
an anti cross-conduction circuit configured to receive the state logic signal, said anti cross-conduction circuit comprising a comparator configured to compare a voltage present at the driver circuit with a first reference voltage corresponding to a deselected drive voltage for inhibiting said anti cross-conduction circuit from closing a corresponding switch for a selected drive voltage for as long as the voltage present at the driver circuit has not yet dropped below the first reference voltage, and configured to switch a reference voltage input to a reference voltage corresponding to the selected drive voltage.

11. The DC-DC converter of claim 10, wherein said selection/de-selection switches comprise P-channel MOS switches having counter-opposed body-drain diodes.

12. The DC-DC converter of claim 10, wherein said anti cross-conduction circuit further comprises:
a first AND gate configured to AND the state logic signal and an output of said comparator, to thereby generate a first drive control signal;
a second comparator configured to compare the first drive control signal with a safety voltage, to thereby generate an active flag when the first drive control signal decreases below the safety voltage; and
a second AND gate configured to AND an inverted replica of the first drive control signal with the active flag, to thereby generate a second drive control signal.

13. An electronic device comprising:
a microprocessor;
a DC-DC converter coupled to said microprocessor and comprising
an output power stage configured to generate a regulated DC supply voltage,
a driver circuit configured to drive the output power stage at an adjustable drive voltage in response to drive control signals, and
a voltage selector configured to select between the different output voltages to be coupled to said driver circuit,
said voltage selector controlled by a state logic signal indicating whether the microprocessor is entering a given power state.

14. The electronic device of claim 13, wherein said voltage selector comprises:
selection/de-selection switches configured to selectively couple the different output voltages for the regulated power supplies of the microprocessor to said driver circuit; and
an anti cross-conduction circuit configured to receive the state logic signal, said anti cross-conduction circuit comprising a comparator configured to compare a voltage present at the driver circuit with a first reference voltage corresponding to a deselected drive voltage for inhibiting said anti cross-conduction circuit from closing a corresponding switch for a selected drive voltage for as long as the voltage present at the driver circuit has not yet dropped below the first reference voltage, and configured to switch a reference voltage input to a reference voltage corresponding to the selected drive voltage.

15. The electronic device of claim 14, wherein said selection/de-selection switches comprise P-channel MOS switches having counter-opposed body-drain diodes.

16. The electronic device of claim 14, wherein said anti cross-conduction circuit further comprises:
a first AND gate configured to AND the state logic signal and an output of said comparator, to thereby generate a first drive control signal;
a second comparator configured to compare the first drive control signal with a safety voltage, to thereby generate an active flag when the first drive control signal decreases below the safety voltage; and
a second AND gate configured to AND an inverted replica of the first drive control signal with the active flag, to thereby generate a second drive control signal.

17. A method of operating a DC-DC converter for powering a microprocessor, the method comprising:
generating a regulated D supply voltage, using an output power stage;
driving the output power stage at an adjustable drive voltage in response to drive control signals, using a driver circuit;
selecting between the different output voltages to be coupled to the driver circuit, using a voltage selector;
controlling the voltage selector with a state logic signal indicating whether the microprocessor is entering a given power state.

18. The method of claim 17, wherein the voltage selector comprises:
selection/de-selection switches configured to selectively couple the different output voltages for the regulated power supplies of the microprocessor to the driver circuit; and
an anti cross-conduction circuit configured to receive the state logic signal, the anti cross-conduction circuit comprising a comparator configured to compare a voltage present at the driver circuit with a first reference voltage corresponding to a deselected drive voltage for inhibiting the anti cross-conduction circuit from closing a corresponding switch for a selected drive voltage for as long as the voltage present at the driver circuit has not yet dropped below the first reference voltage, and configured to switch a reference voltage input to a reference voltage corresponding to the selected drive voltage.

19. The method of claim 18, wherein the selection/de-selection switches comprise P-channel MOS switches having counter-opposed body-drain diodes.

20. The method of claim 18, wherein the anti cross-conduction circuit further comprises:
a first AND gate configured to AND the state logic signal and an output of the comparator, to thereby generate a first drive control signal;
a second comparator configured to compare the first drive control signal with a safety voltage, to thereby generate an active flag when the first drive control signal decreases below the safety voltage; and
a second AND gate configured to AND an inverted replica of the first drive control signal with the active flag, to thereby generate a second drive control signal.
